(19) United States
(12) Patent Application Publication
(10) Pub. No.: US 2025/0251701 A1
(43) Pub. Date: Aug. 7, 2025

(54) Three-Dimensional Programmable Watch Winder Apparatus With Customizable Movement

(71) Applicant: Abayomi Olusegun Aiyegbusi, London (GB)

(72) Inventor: Abayomi Olusegun Aiyegbusi, London (GB)

(21) Appl. No.: 18/434,985

(22) Filed: Feb. 7, 2024

(51) Int. Cl. G04D 7/00

(52) U.S. Cl. CPC G04D 7/009

(57) ABSTRACT

The invention discloses a watch winder apparatus designed to enhance the winding process of mechanical watches through a sophisticated three-dimensional movement system. The apparatus features a housing that supports a uniquely designed gyroscope and gimbal mechanism. This mechanism incorporates a gimbal with a watch-holding chamber, and at least three segments rotatably coupled to enable motion in three distinct axes. Each segment's movement is driven by a dedicated set of actuators, allowing for precise control over the gimbal's orientation and rotation. A programmable microprocessor circuit within the apparatus orchestrates the operation of these actuators, enabling the execution of pre-programmed movement patterns tailored to optimally wind the watch. The microprocessor also tracks the rotations performed by each component, ensuring accurate and efficient energy transfer to the watch's mechanism.

### FIELD OF INVENTION

The present invention relates generally to the field of horological devices, specifically to an apparatus for winding mechanical watches. It focuses on a programmable watch winder capable of simulating three-dimensional movements to closely mimic the natural motion of a watch on the wearer's wrist, enabling precise and customizable winding sequences.

### BACKGROUND

The realm of horology has long recognized the significance of maintaining the precision and longevity of mechanical watches through the use of watch winders. Traditional watch winders have predominantly focused on providing rotational movement to simulate the basic motion of a watch as it is worn on the wrist, aiming to keep the watch's internal mechanism operational by winding the mainspring. However, these conventional devices have been limited to offering primarily two-dimensional motion patterns, which, while beneficial, do not fully capture the complex dynamics of human movement. This limitation is particularly noticeable in the context of high-end mechanical watches, which may benefit from a more nuanced approach to winding that better replicates the varied orientations and movements experienced during actual wear.

Current watch winding technologies often fall short in their ability to offer this nuanced approach, primarily because they are designed to rotate a watch in a single plane or along a fixed set of axes. This method is somewhat effective for general maintenance but does not consider the intricate and multidirectional movements that occur when a watch is worn on the wrist. Watches, especially those of the automatic variety, are designed to be wound by the natural movements of the wearer's body, which include a wide range of motions not traditionally replicated by existing winders.

Furthermore, the lack of programmability in many existing winders restricts the ability to customize winding patterns to the specific needs or preferences of the watch or its wearer. The ability to adjust for different winding requirements—such as the number of rotations needed to fully wind the watch, the direction of winding, or the introduction of pauses and variations in motion—can be crucial for the optimal maintenance and accuracy of mechanical timepieces. The introduction of a delay before winding begins or the creation of cyclical winding patterns that mimic natural wear patterns could significantly enhance the efficacy of the winding process.

Recognizing these limitations, there is a clear demand for innovation within the field of watch care and maintenance. The development of a watch winder capable of delivering a broader spectrum of movements, encompassing three-dimensional motion and providing customizable, pre-programmed winding sequences, represents a significant advancement. Such a device would not only address the shortcomings of traditional winders by offering a more realistic simulation of the conditions under which a watch is worn but also introduce a level of precision and customization previously unattainable. This advancement is poised to redefine the standards of watch care, catering to the sophisticated mechanisms of high-end watches and the discerning preferences of their owners.

It is within this context that the present invention is provided.

### SUMMARY

The present invention relates to a watch winder apparatus designed to improve the care and maintenance of mechanical watches by simulating the complex movements of the human hand and wrist in three dimensions. The apparatus consists of a housing supporting a gyroscope and gimbal mechanism, with the gimbal including a chamber for holding a watch and having at least three rotatably coupled segments. Each segment is capable of rotating about a distinct axis, facilitated by corresponding sets of actuators. This design allows for movement in three dimensions, offering a more sophisticated method of winding watches. The apparatus is powered by a supply and incorporates a programmable microprocessor circuit for controlling the actuators, enacting pre-programmed movements, and tracking rotations.

In some embodiments, the apparatus includes a user interface allowing for interaction with the device, including setting rotation numbers and pause lengths. This feature enhances user control and customization of the winding process, tailoring it to the specific needs of individual watches.

The user interface may comprise a resistive touch display, providing a visual and interactive method for adjusting operational settings and receiving feedback on the apparatus's status. This facilitates ease of use and allows for intuitive operation of the device.

The incorporation of a pre-programmable microprocessor and interface within the watch winder apparatus significantly enhances its functionality by enabling the automation of virtually any movement pattern a user may desire. This feature allows for the precise control and customization of the gimbal's motion, ensuring that the winding process can be tailored to the specific requirements of any watch. Users can input desired movement patterns, including the number of rotations, the direction of those rotations, and even complex sequences that include pauses or changes in speed, directly through the user interface.

Thus, in further embodiments, the microprocessor circuit is configured to perform operations such as introducing delay periods before rotation begins, interrupting rotation with pauses, and predetermining the number of rotations in each set based on user instructions. This adds a level of sophistication to the winding process, mimicking the irregular movements of a watch on the wrist more closely.

The number of rotations and the pause length between rotations for each of the rotating components are adjustable via the user interface, offering precise control over the winding cycle to accommodate the diverse requirements of different mechanical watches.

Some embodiments include a fingerprint reader for user authentication, enhancing the security of the device and ensuring that its settings and operation are accessible only to authorized users. The fingerprint reader is connected to the microprocessor circuit via UART pins, enabling efficient biometric data processing.

The microprocessor circuit may also comprise built-in Wi-Fi and Bluetooth modules, facilitating wireless connectivity and enabling remote operation and monitoring of the device.

The actuators in the device comprise servo motors, each controlled by Pulse Width Modulation (PWM) signals from the microprocessor circuit. This allows for precise control over the movement of each gimbal segment, ensuring accurate and effective winding of the watch.

The microprocessor circuit is programmable for executing specific tasks such as user authentication, display management, motor position setting, and the first-time enrolment of fingerprints and passcodes, providing a comprehensive and secure user experience.

In one embodiment, the gimbal mechanism's structure, with three rotatably connected segments mounted atop a base, enables the apparatus to mimic a wide range of natural wrist movements. The base, a C-shaped element, provides stable support for the gimbal and gyroscope assembly, with actuators configured to rotate each segment about its respective axis. The first segment, a ring-shaped element, tilts about the Y-axis, while the second, a cylindrical or coin-shaped element, rotates about the X-axis. The third segment, a gimbal shaft, rotates about the Z-axis, all facilitated by dedicated sets of actuators. This arrangement achieves a dynamic simulation of the varied movements of a watch as it is worn on the wrist. This embodiment may also optionally feature a telescopic gimbal shaft controlled by a fourth set of actuators, allowing for vertical adjustment of the timepiece chamber. This provides additional customization of the watch's positioning within the apparatus.

### BRIEF DESCRIPTION OF THE DRAWINGS

Various embodiments of the invention are disclosed in the following detailed description and accompanying drawings.

Common reference numerals are used throughout the figures and the detailed description to indicate like elements. One skilled in the art will readily recognize that the above figures are examples and that other architectures, modes of operation, orders of operation, and elements/functions can be provided and implemented without departing from the characteristics and features of the invention, as set forth in the claims.

### DETAILED DESCRIPTION AND PREFERRED EMBODIMENT

The following is a detailed description of exemplary embodiments to illustrate the principles of the invention. The embodiments are provided to illustrate aspects of the invention, but the invention is not limited to any embodiment. The scope of the invention encompasses numerous alternatives, modifications and equivalent; it is limited only by the claims.

Numerous specific details are set forth in the following description in order to provide a thorough understanding of the invention. However, the invention may be practiced according to the claims without some or all of these specific details. For the purpose of clarity, technical material that is known in the technical fields related to the invention has not been described in detail so that the invention is not unnecessarily obscured.

### Definitions

The terminology used herein is for the purpose of describing particular embodiments only and is not intended to be limiting of the invention.

As used herein, the term “and/or” includes any combinations of one or more of the associated listed items.

As used herein, the singular forms “a,” “an,” and “the” are intended to include the plural forms as well as the singular forms, unless the context clearly indicates otherwise.

It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

### DESCRIPTION OF DRAWINGS

The detailed description of the present invention provides an in-depth exposition of a novel watch winder apparatus designed to offer an advanced level of precision and customization in the care and maintenance of mechanical watches. This apparatus, through its innovative design and utilization of a gyroscope and gimbal mechanism, seeks to replicate the complex, multidirectional movements that a watch undergoes when worn on the human wrist.

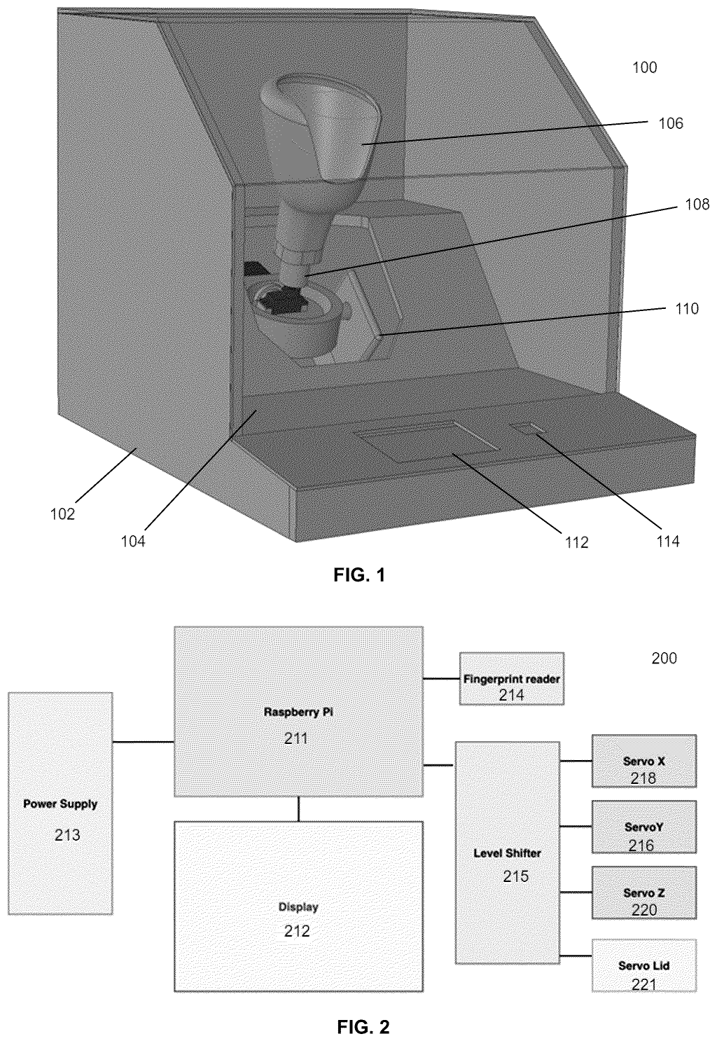

FIG. 1 depicts an isometric view of the watch winding apparatus, designated as 100, showcasing its principal components. The housing 102 forms the core structure of the apparatus, providing stability and protection. A protective lid 104 ensures the safety of the timepiece during operation, while a timepiece chamber 106 securely holds the watch in place. The gimbal shaft 108, mounted on the base 110, facilitates the dynamic movement of the chamber. A touchscreen display 112 offers an interactive interface for users to customize settings, complemented by a fingerprint reader 112 for secure access.

FIG. 2 illustrates a block diagram of the electronic components that drive the apparatus 200. The power supply 213 ensures a consistent energy source, while a Raspberry Pi microcontroller 211 acts as the central processing unit, managing operations and interactions. The display 212, coupled with the fingerprint reader 214, forms the user interface. A level shifter 215 connects the microcontroller to a set of servo motors that control the movement axes: an X servo 218, a Y servo 216, a Z servo 220, and an additional servo 221 for the lid's operation.

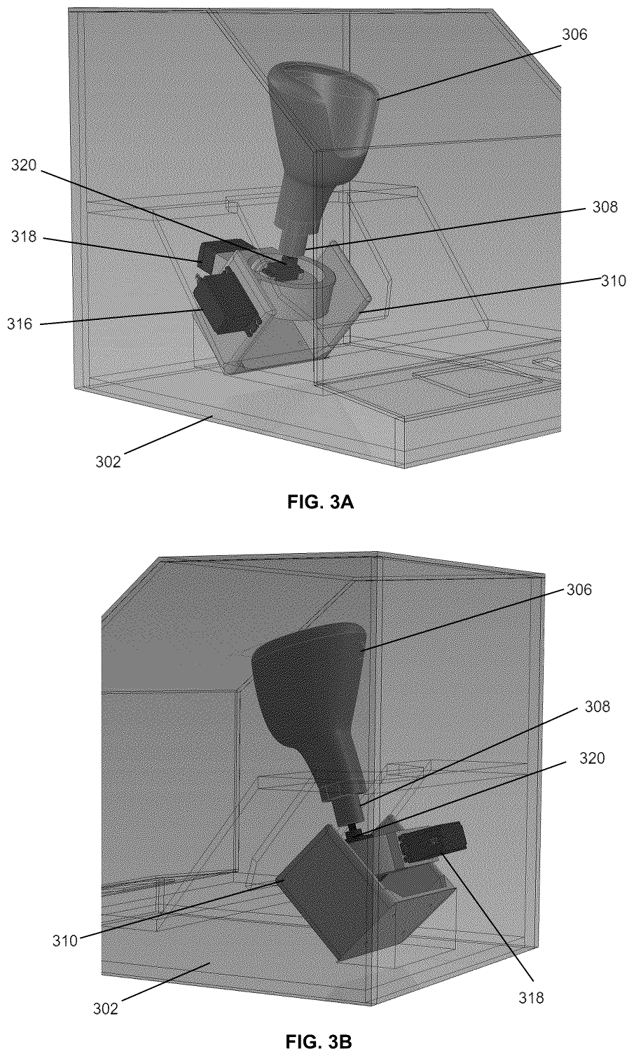

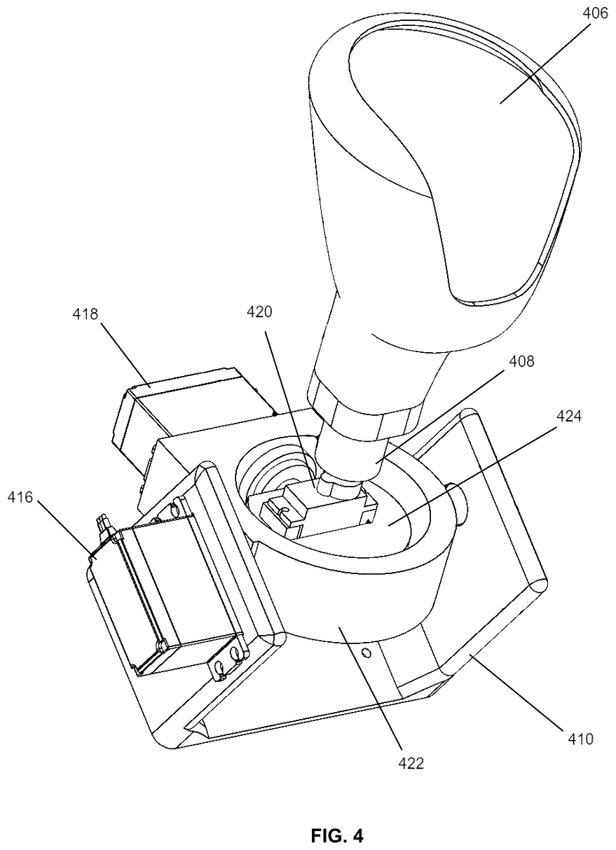

FIG. 3A and FIG. 3B offer front and rear views of the gyroscope and gimbal mechanism within the apparatus 300, further detailing the arrangement and cooperation of its moving parts. These figures emphasize the integration of the housing 302, timepiece chamber 306, gimbal shaft 308, and base 310, along with the servo motors responsible for the X, Y, and Z axes movements: Y servo 316, X servo 318, and Z servo 320, respectively.

FIG. 4 provides a closer look at the gyroscope and gimbal mechanism, isolating it for a detailed examination. It highlights the critical components like the timepiece chamber 406, gimbal shaft 408, and base 410, in addition to illustrating the positioning and function of the Y servo 416, X servo 418, and Z servo 420. The first and second segments, 422 and 424, demonstrate the modular design allowing for comprehensive motion control.

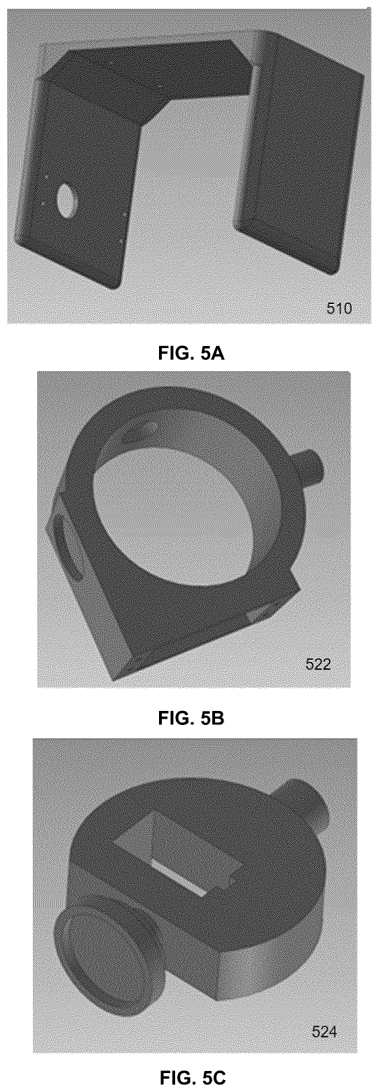

FIGS. 5A, 5B, and 5C dissect the gyroscope and gimbal mechanism into its foundational elements, showcasing the base 510, the first ring-shaped segment 522, and the second coin-shaped segment 524. These components underscore the intricate design and operational synergy that facilitate the apparatus's unique motion capabilities.

Drawing inspiration from the dynamic range of movement of an automotive gear lever, the invention integrates vertical and rotational motions into the timepiece chamber's operation around the Z-axis. The apparatus comprises a housing with a base and three segments, each rotatably connected and capable of rotating about a distinct axis, enabled by three sets of actuators. This configuration allows for precise control over the chamber's movement in three-dimensional space, mirroring the complex movements experienced by a watch on the wrist.

The base, a C-shaped element, anchors the assembly, providing stability and support. It houses the first set of actuators, which initiate the Y-axis rotation. The subsequent segments, influenced by additional sets of actuators, facilitate rotations about the X and Z axes, respectively, allowing for a comprehensive simulation of wrist movements.

### Microcontroller

The controller/microprocessor as described herein can be any suitable type of computer. A computer may be a uniprocessor or multiprocessor machine. Accordingly, a computer may include one or more processors and, thus, the aforementioned computer system may also include one or more processors. Examples of processors include sequential state machines, microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), gated logic, programmable control boards (PCBs), and other suitable hardware configured to perform the various functionality described throughout this disclosure.

Additionally, the computer may include one or more memories. Accordingly, the aforementioned computer systems may include one or more memories. A memory may include a memory storage device or an addressable storage medium which may include, by way of example, random access memory (RAM), static random access memory (SRAM), dynamic random access memory (DRAM), electronically erasable programmable read-only memory (EEPROM), programmable read-only memory (PROM), erasable programmable read-only memory (EPROM), hard disks, floppy disks, laser disk players, digital video disks, compact disks, video tapes, audio tapes, magnetic recording tracks, magnetic tunnel junction (MTJ) memory, optical memory storage, quantum mechanical storage, electronic networks, and/or other devices or technologies used to store electronic content such as programs and data. In particular, the one or more memories may store computer executable instructions that, when executed by the one or more processors, cause the one or more processors to implement the procedures and techniques described herein. The one or more processors may be operably associated with the one or more memories so that the computer executable instructions can be provided to the one or more processors for execution. For example, the one or more processors may be operably associated to the one or more memories through one or more buses. Furthermore, the computer may possess or may be operably associated with input devices (e.g., a keyboard, a keypad, controller, a mouse, a microphone, a touch screen, a sensor) and output devices such as (e.g., a computer screen, printer, or a speaker).

The computer may advantageously be equipped with a network communication device such as a network interface card, a modem, or other network connection device suitable for connecting to one or more networks.

A computer may advantageously contain control logic, or program logic, or other substrate configuration representing data and instructions, which cause the computer to operate in a specific and predefined manner as, described herein. In particular, the computer programs, when executed, enable a control processor to perform and/or cause the performance of features of the present disclosure. The control logic may advantageously be implemented as one or more modules. The modules may advantageously be configured to reside on the computer memory and execute on the one or more processors. The modules include, but are not limited to, software or hardware components that perform certain tasks. Thus, a module may include, by way of example, components, such as, software components, processes, functions, subroutines, procedures, attributes, class components, task components, object-oriented software components, segments of program code, drivers, firmware, micro code, circuitry, data, and/or the like.

The control logic conventionally includes the manipulation of digital bits by the processor and the maintenance of these bits within memory storage devices resident in one or more of the memory storage devices. Such memory storage devices may impose a physical organization upon the collection of stored data bits, which are generally stored by specific electrical or magnetic storage cells.

The control logic generally performs a sequence of computer-executed steps. These steps generally require manipulations of physical quantities. Usually, although not necessarily, these quantities take the form of electrical, magnetic, or optical signals capable of being stored, transferred, combined, compared, or otherwise manipulated. It is conventional for those skilled in the art to refer to these signals as bits, values, elements, symbols, characters, text, terms, numbers, files, or the like. It should be kept in mind, however, that these and some other terms should be associated with appropriate physical quantities for computer operations, and that these terms are merely conventional labels applied to physical quantities that exist within and during operation of the computer based on designed relationships between these physical quantities and the symbolic values they represent.

It should be understood that manipulations within the computer are often referred to in terms of adding, comparing, moving, searching, or the like, which are often associated with manual operations performed by a human operator. It is to be understood that no involvement of the human operator may be necessary, or even desirable. The operations described herein are machine operations performed in conjunction with the human operator or user that interacts with the computer or computers.

It should also be understood that the programs, modules, processes, methods, and the like, described herein are but an exemplary implementation and are not related, or limited, to any particular computer, apparatus, or computer language. Rather, various types of general-purpose computing machines or devices may be used with programs constructed in accordance with some of the teachings described herein. In some embodiments, very specific computing machines, with specific functionality, may be required.

### CONCLUSION

Unless otherwise defined, all terms (including technical terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

The disclosed embodiments are illustrative, not restrictive. While specific configurations of the watch winding apparatus of the invention have been described in a specific manner referring to the illustrated embodiments, it is understood that the present invention can be applied to a wide variety of solutions which fit within the scope and spirit of the claims. There are many alternative ways of implementing the invention.

It is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A watch winder apparatus comprising:
a housing configured to support a gyroscope and gimbal mechanism;
a gimbal within the housing, the gimbal including a chamber at its top configured to hold a watch and comprising at least three rotatably coupled segments, each segment being capable of rotating about a distinct axis, thereby allowing for movement in three dimensions;
at least three corresponding sets of actuators, each set of actuators coupled to a respective one of the rotating components of the gimbal, to facilitate the controlled movement of each component;
a power supply; and
a programmable microprocessor circuit housed within the apparatus, the microprocessor circuit configured to control the operation of the actuators to enact one or more pre-programmed movements of the gimbal and chamber, and to track the number of rotations executed by each of the rotating components.

2. The watch winder apparatus of claim 1, wherein the apparatus further comprises a user interface for interacting with the apparatus, including setting the number of rotations and pause lengths.

3. The watch winder apparatus of claim 2, wherein the user interface comprises a restive touch display for displaying operational status, settings, and receiving user inputs to control the apparatus functions.

4. The watch winder apparatus of claim 2, wherein the microprocessor circuit is further configured to perform one or more of the following operations based on user instructions received via the user interface: introduce a delay period after activation before the gimbal commences rotating, interrupt the rotation of the gimbal with pauses to break up the movements into cyclical sets, and automatically predetermine the number of rotations in each set.

5. The watch winder apparatus of claim 2, wherein the number of rotations and the pause length between rotations for each of the rotating components are adjustable via the user interface.

6. The watch winder apparatus of claim 1, further comprising a fingerprint reader for user authentication, wherein the programmable microprocessor circuit is configured to control access to the apparatus based on fingerprint verification.

7. The watch winder apparatus of claim 6, wherein the fingerprint reader is connected to the microprocessor circuit via UART pins, enabling biometric data processing for authenticating users.

8. The watch winder apparatus of claim 1, wherein the microprocessor circuit further comprises a built-in Wi-Fi and Bluetooth module

9. The watch winder apparatus of claim 1, wherein the actuators comprise servo motors, each servo motor being controlled by Pulse Width Modulation (PWM) signals from the microprocessor circuit for precise movement control.

10. The watch winder apparatus of claim 1, wherein the microprocessor circuit is programmable to execute specific user authentication, display management, motor position setting, and first-time enrolment of fingerprint and passcode.

11. The watch winder apparatus of claim 1, wherein the three rotatably connected segments are mounted atop a base, the axis of rotation of the first segment being the Y axis, the axis of rotation of the second segment being the X axis, and the axis of rotation of the third segment being the Z-axis.

12. The watch winder apparatus of claim 11, wherein the base is a C-shaped element that secures to the housing and forms the load-bearing support for the gimbal and gyroscope assembly, the base including a first set of actuators configured to rotate the first segment about the Y-axis.

13. The watch winder apparatus of claim 12, wherein the first segment is a ring-shaped element, and the first set of actuators causes the plane of the ring to tilt about the Y-axis, the first segment further comprising a second set of actuators for rotating a second segment about the X-axis.

14. The watch winder apparatus of claim 13, wherein the second segment is a cylindrical or coin-shaped element that rests within the inner circumference of the ring of the first segment and rotates about the X-axis, the rotation of the second segment being facilitated by the second set of actuators.

15. The watch winder apparatus of claim 14, wherein the third segment is a gimbal shaft coupled to a flat surface at the top of the second segment via a third set of actuators embedded within said top surface, wherein the third set of actuators controls the rotation of the gimbal shaft about the Z-axis.

16. The watch winder apparatus of claim 15, further comprising a telescopic gimbal shaft controlled by a fourth set of actuators, allowing for adjustment of the height of the timepiece chamber along the Z-direction, providing additional customization of the watch positioning within the apparatus.
